(19) United States
(12) Patent Application Publication
(10) Pub. No.: US 2007/0034262 A1
(43) Pub. Date: Feb. 15, 2007

(54) Pressure relief valve

(76) Inventors: Eric Cozens, Burlington (CA); Paul Morton, Oakville (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/501,110

(22) Filed: Aug. 9, 2006

Related U.S. Application Data
(60) Provisional application No. 60/706,457, filed on Aug. 9, 2005.

(51) Int. Cl. F16K 15/00

(52) U.S. Cl. 137/513

(57) ABSTRACT

A dual plunger valve having nested inner and outer plungers seated within a bore in the valve housing. The valve housing has an inlet port and an outlet port fluidly connected by the bore and sealed from one another by the plungers which are biased towards respective sealing surfaces by a pair of nested biasing elements located between the inlet port and the outlet port. The outer plunger is slidable within the bore and has a lip extending inwardly therefrom. The inner plunger is slidable within the outer plunger between a sealed position and a second position wherein it is in contact with the lip. Pressure in the inlet port which is high enough to overcome the force of the biasing elements causes the inner plunger to slide within the outer plunger to its second position wherein the outer plunger will then begin to slide within the bore to remove the seal between the inlet port and the outlet port.

This application claims priority from U.S. provisional application no. 60/706,457 filed on Aug. 9, 2005.

### FIELD OF THE INVENTION

The present invention relates to pressure relief valves used in fluid systems.

### DESCRIPTION OF THE PRIOR ART

Pressure relief valves used in fluid systems are generally one-way valves designed to open at a specific pressure to prevent damage to the system. For example, a pressure relief valve is used in an engine's lubrication system to relieve excessive pressure that may develop in the oil pump as the engine speed increases or downstream of the pump if an unpredictable restriction occurs.

Pumps used in fluid systems are susceptible to contamination. In the case of an engine the contamination generally originates in the engine and may comprise particles of iron, aluminum, sand etc. Although filters and inlet screens are provided, the system is designed on the assumption that some particles of contaminate will reach the pump, which therefore are designed to pass the contaminates through the pump without issue.

A conventional relief valve has a seat in a bore with a valve member biased into engagement with the seat. There is a nominal clearance between the bore and the valve member to maintain a seal when the valve is closed. An effective seal is necessary to ensure priming of the pump as the engine starts, particularly where the pump is mounted in an elevated position and flow past the valve is re-circulated to the inlet. If a contaminate particle becomes lodged between the valve member and the bore, the relief valve will become wedged into an open position. With the relief valve wedged open, the pump will drain when the engine is switched off and may not prime when the engine is initially started. This can lead to premature failure of the engine. The tendency for particles to become wedged is particularly evident when the pressure drops in the pump and the valve is closing, i.e. when the engine is shut down, and thereby exacerbates the problem.

U.S. Pat. No. 4,953,588 to Sands discloses a check valve assembly in which a pair of poppet valves is arranged to act independently of one another to seal a line. The purpose of this assembly is to inhibit reverse flow if one of the poppets fails. The Sands patent is directed to check valves where only a nominal resistance to flow is envisaged rather than relief at an elevated pressure. As such the independent operation of the valves is of primary concern rather than the pressure/flow characteristics of a relief valve. If used as a relief valve, the independent nature of each of the valves would require each to function as a separate relief valve in series, causing significant difficulties in matching their operation to regulate the pressure accurately.

It is therefore an object of the present invention to obviate or mitigate the above mentioned disadvantages.

### SUMMARY OF THE INVENTION

In one aspect, a valve for a fluid system is provided comprising a housing, the housing having an inlet port, an outlet port, a bore fluidly connecting the inlet port to the outlet port, an inner sealing surface and an outer sealing surface at spaced locations between the inlet port and the outlet port. The valve also comprises an outer sealing member slidably located within the bore and having a sealing face biased into engagement with the outer sealing surface by an outer biasing element and a circumferential sealing surface that engages a portion of the wall of the bore extending axially between the inlet and the outlet; and an inner sealing member nested within the outer plunger and being sealingly engaged with the inner sealing surface by an inner biasing element. The outer plunger is moveable to an open position in which fluid flows between the inlet port and the outlet port.

### BRIEF DESCRIPTION OF THE DRAWINGS

An embodiment of the invention will now be described by way of example only with reference is made to the appended drawings wherein:

FIG. 1 is a schematic representation of a hydraulic pump with a pressure relief valve.

FIG. 2 is a cross sectional view of the valve of FIG. 1 along line II-II.

FIG. 3 is a series of views showing the operation of the valve of FIG. 2 under different conditions.

FIG. 4 is a cross sectional view of an alternative embodiment of valve to that shown in FIG. 2.

### DETAILED DESCRIPTION OF THE INVENTION

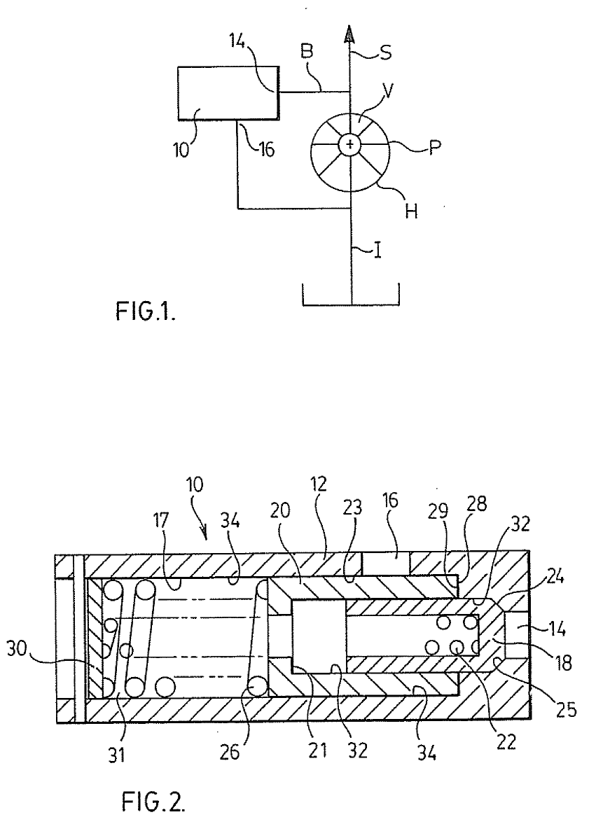

Referring therefore to FIGS. 1 and 2, an oil supply for an engine includes a pump P having a vaned impeller V driven by the engine and rotating within a pump housing H. Oil is drawn in to the housing H by an inlet I and delivered to a supply port S. A bypass path B is provided between the supply port S and inlet I to permit oil to be re-circulated from the supply port S to the inlet I. Flow through the bypass path B is controlled by a valve 10 which opens to permit flow when the pressure in the supply port S exceeds a predetermined value and closes when the pressure of oil drops below that value. In many installations, the pump P is mounted at an elevated location on the engine and draws oil through the inlet I into the housing H from the sump below the engine.

Valve 10 generally comprises a valve housing 12 with an inlet pressure port 14 connected to the supply port S and an exhaust port 16 connected to the bypass path B. The inlet port 14 and exhaust port 16 are axially spaced along a stepped bore 17.

The stepped bore 17 extends within the valve housing 12 from the inlet port 14 past the outlet port 16 to a recess 31 in the housing 12. A pair of radial seats 24, 28 are formed in the bore 17 separated by an inner circumferential sealing surface 32. The radial seat 24 is positioned adjacent the inlet port 14 and extends between the port and the inner sealing surface 32. The radial seat 28 extends between the inner sealing surface 32 and an outer circumferential sealing surface 34 defining a major extent of the bore 17 and which is intersected by the exhaust port 16. A retainer provided by a retaining disc 30 and secured by a pin (or other means), is located in the recess 31.

An inner sealing member or plunger 18 and an outer sealing member or plunger 20 are nested within the bore 17 and are biased towards the inlet port 14 by respective inner and outer springs 22, 26. The outer plunger 20 is formed as a cylindrical sleeve with a sealing face 29 at one end and a radial lip 21 at the opposite end. The sealing face 29 is biased into engagement with the outer radial sealing surface 28 by the outer spring 26 which acts between the lip 21 and the retaining disc 30. The outer plunger 20 is sized to provide a close sliding fit within the bore 17 between the radial face 29 and the outlet 16. This maintains a seal between its outer surface 23 and the outer circumferential sealing surface 34 whilst it slides within the bore 17 and thus provides a pair of separate sealing bands, one radial and one circumferential (extending axially along bore), between the plunger 20 and bore 17.

The inner plunger 18 is formed as a “cup shaped” member with a sealing face 25 at one end opposed to the inner sealing face 24 in the bore 17. The plunger 18 also is a close sliding fit within the inner circumferential sealing surface 32 to provide seal between the plunger 18 and bore 17. The sealing face 25 is biased into engagement with the inner radial seat 24 by the inner spring 22 which is seated between the interior of the plunger 18 and the retainer 30 and nested within the outer spring 26. The inner plunger 18 is a sliding fit within the outer plunger 20 to maintain a seal between the two plungers 18, 20 over the axial extent of their sliding engagement. The rear end of the inner plunger 18 abuts the lip 21 to limit relative movement between the plungers 18, 20. The relationship between the plungers 18, 20 also helps to protect the spring 22 from hitting solid height or experiencing premature fatigue failure.

The position shown in FIG. 2 illustrates the valve under normal operating conditions wherein the pressure of the fluid in the inlet port 14 is at or below the maximum desired operating pressure of the particular component utilizing the valve 10. In this position, a seal is provided between the plunger 18 and both the radial face 24 and circumferential seal 32 and a further pair of seals between the plunger 20 and the radial face 28 and circumferential seal 34. In addition a sliding seal is provided between the plungers 18, 20.

As the pressure in the inlet port 14 rises, the force imparted on the sealing face 25 will cause the inner plunger 18 to compress the inner spring 22 and begin to slide within the outer plunger 20. During this movement, a seal is maintained between the plunger 18 and the circumferential face 32. The biasing force of the inner spring 22 is chosen to respond to changes in pressure such that at a predetermined value, below the crack or opening pressure, it will have overcome the biasing force imparted by the inner spring 22 on the inner plunger 18 which then abuts the lip 21.

Upon abutment of the plunger 18 with the lip 21, further increase in the pressure causes a corresponding conjoint movement of the plungers 18, 21 against the bias of both springs 22, 26 with the pressure acting on the entire face of both plungers.

A seal is maintained between the inlet port 14 and the exhaust port 16 until the sealing face 29 of the outer plunger 20 uncovers the exhaust port 16. Upon exposure of the port 16, fluid present in the inlet port 14 may pass through the exhaust port 16 to maintain pressure in the supply port S at a predetermined value.

It will be appreciated that the outer plunger 20 may also be designed to move without requiring the inner plunger 18 to engage the lip 21. For example, the sealing face 29 may be designed to be partially exposed such that a predetermined pressure (and corresponding spring) will also move the outer plunger 20.

The plungers 18, 20 will regain the position seen in FIG. 2 when the pressure in the inlet port 14 falls below the maximum desired pressure. The biasing forces imparted by the springs 22, 26 will cause the plungers 18, 20 to slide back into position when these forces are able to overcome the force imparted on the sealing faces 25, 29 by the fluid pressure in the inlet port 14. Initially the inner and outer plungers 18, 20 move in unison until the outer plunger 20 engages the radial face 29. Thereafter, the inner plunger 18 extends from the outer plunger 20 until the end face 25 seats against the seat 24. It will be noted that the plungers 18, 20 act in unison against a common bias during opening, thereby facilitating control of relief pressure.

As noted above, the oil in the sump of the engine may carry contaminants that interfere with the normal operation of the valve. If the valve 10 is lodged in an open position, a direct connection between the supply port s and inlet port I is provided that inhibits the priming of the pump when the engine is restarted. The provision of the multiple sealing surfaces and the independent operation of the plungers mitigates the impact on the operation of the valve and permits priming of the pump in all but the most extreme situations.

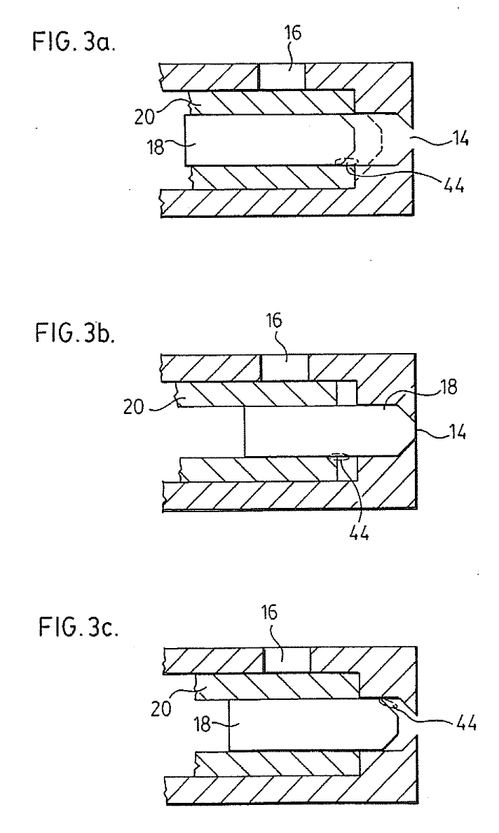

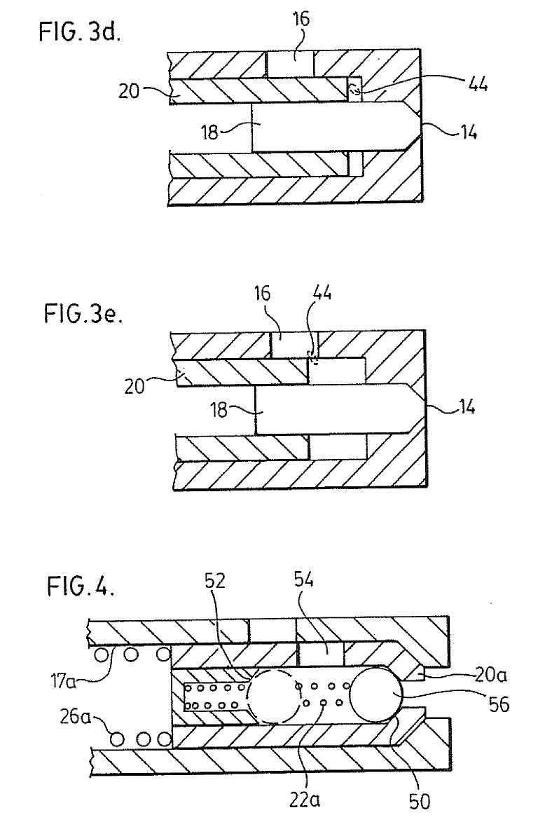

As shown in FIG. 3a, contaminant 44 may become lodged between the plungers 18, 20 to inhibit relative sliding movement. If the inner plunger 18 is held within the plunger 20, the outer plunger 20 is operable to move to a closed position with a seal on the radial face 28 and circumferential seal 34. Thus an effective seal is provided that allows rejoining of the pump. Moreover, the valve 10 will continue functioning to relieve pressure.

If the plunger 18 is wedged so that it partially extends from the plunger 20, an additional seal is provided between the plunger 18 and circumferential face 32.

Alternatively, the plunger 18 may be wedged whilst partially extended as shown in FIG. 3b. In that position, the plunger 18 will seat against radial face 24 and seal against inner circumferential seal 32 although the outer plunger 20 is held away from its sealing position. The valve is therefore operable to seal the pump cavity and re-prime the pump.

Typically, the wedging by the contaminant is a transient condition and is freed at the next operation of the pump by flow of fluid under pressure.

Contaminants may also become lodged against the radial seats 24, 28 as illustrated in FIGS. 3c and 3d respectively. The independent movement of the plungers 18, 20 permits an effective seal to be obtained to provide priming. Where the contaminant to present against the radial seat 24, as shown in FIG. 3c a seal will be established on the circumferential wells 32, 34 and the radial seat 28.

Similarly, where a contaminant is present on the radial seat 28, a seal will be established at the circumferential walls 32, 34 and the radial seat 24.

In both cases the pump will be able to re-prime and the valve will function as a relief valve upon restarting of the pump.

A further potential failure made is shown in FIG. 3e where contaminant is lodged at the outlet 16 and prevents the outer plunger 20 from reseating. In this condition, the inner plunger is free to move to a sealing position under the bias of the spring so that a seal is established at the radial face 24 and the circumferential seal 32. Again therefore, repriming of the pump is facilitated and pressure can be built up in the hydraulic circuit once the pump is re-primed.

Should one of the springs fail, the independent operation of the plunger will again ensure effective sealing and continued operation under the influence of the remaining spring.

Accordingly, it can be seen that a redundancy is integrated in the valve to accommodate potential failure modes.

A further embodiment of the valve 10 is shown in FIG. 4 where like reference numerals will be used to denote like components with a suffix a added for clarity. In the embodiment of FIG. 4, the outer plunger 20a is modified to provide a pair of part spherical seats 50, 52 at axially spaced locations within the plunger 20a. A cross port 54 is provide in the plunger 22a between the seats 50, 52 the cross port 54 is located on the plunger 22a such that it is not aligned with the exhaust port 16a when the plunger 22a is against the seat 24a but will be moved in to alignment as the plunger 22a slides away from the seat 24a.

Inner plunger 18 is replaced with a ball 56 of a diameter corresponding to the diameter of the seats 50, 52. A spring 22a acts against the ball 56 to hold it against the seat 50 and inhibit flow from the supply port S to the inlet I. When the pressure in the supply port S exceeds the bias of spring 22a, the ball 56 is moved towards the seat 52, and, as the pressure increases, the entire face of the plunger 20a and ball 56 is subjected to hydraulic pressure. The plunger 20a acts against the bias of the spring 26a and moves axially within bore 17a until the cross port 54 is aligned with exhaust port 16a. Re-circulating flow can then occur through the seat 50 and the cross port 54. If the pressure drops, the ball 54 is held against the seat 52 until the plunger 22a has again closed the exhaust port 16a, and, as the pressure continues to drop, the ball 54 will be moved in to engagement with the seat 50.

It will be apparent that if the ball 54 is held off the seat 50 due to contaninants, the outer plunger 22a will again provide a seal at the radial seat 24a and the circumferential seal 34a to permit re-priming of the pump P. If the plunger 22a is held open, the ball 54 will seat against the seat 50 and close the flow path through the seat 50 to the exhaust port 16a. Again therefore redundancy is provided to mitigate the potential for the valve 10 to be held in an open position and inhibit re-priming of the pump P. Although the two “cracking” pressures, namely for the ball 54 and plunger 22a, are typically different, this would still protect the engine from a “no prime” condition.

If a chip or contaminate particle becomes stuck between the ball 54 and the face of the plunger 22a, the ball 54 will re-align itself and still provide a partial circumferential seal. This will aid in engine priming since the leak path is smaller.

The ball 54 also provides the advantage of a smoother flow path as fluid passes over the face of the ball 54 and exits the valve 10. This encourages contaminate particles to exit the system.

Although the invention has been described with reference to certain specific embodiments, various modifications thereof will be apparent to those skilled in the art without departing from the spirit and scope of the invention as outlined in the claims appended hereto.

What is claimed is:

1. A valve for use in fluid systems comprising:
(a) a housing, said housing having an inlet port, an outlet port, a bore fluidly connecting said inlet port to said outlet port;
(b) an inner sealing surface and an outer sealing surface at spaced locations between said inlet port and said outlet port;
(c) an outer sealing member slidably located within said bore and having a sealing face biased into engagement with said outer sealing surface by an outer biasing element and a circumferential sealing surface that engages a portion of the wall of said bore extending axially between said inlet and said outlet; and
(d) an inner sealing member located within said outer plunger and being sealingly engaged with said inner sealing surface by an inner biasing element;
wherein said outer sealing member is moveable to an open position in which fluid flows between said inlet port and said outlet port.

2. A valve according to claim 1 wherein said inner sealing member comprises a ball and said inner sealing surface is provided by said outer sealing member whereby said ball is slidable within said outer sealing member between said abutment and said inner sealing surface.

3. A valve according to claim 2 wherein outer sealing surface is inclined with respect to the wall of said bore.

4. A valve according to claim 2 wherein said outer sealing surface surrounds said inlet and said inner sealing surface surrounds an passage in said outer sealing member aligned with said inlet.

5. A valve according to claim 1 wherein said biasing elements are springs.

6. A valve according to claim 5 wherein said springs are nested.

7. A valve according to claim 1 wherein said outer sealing member comprises an opening separating said circumferential sealing surface and said outer sealing surface for aligning with said outlet in said open position.

8. A valve according to claim 1, said outer sealing member having an open end for receiving said inner sealing member, said inner sealing member comprising a closed end for sealing said inlet, said bore being stepped inwardly toward said inlet to provide said outer sealing surface and to provide an inner bore extending between said outer sealing surface and said inlet for receiving a portion of said inner sealing member to engage said inner sealing member.

9. A valve according to claim 8 wherein said inner sealing surface is inclined with respect to said inner bore.

10. A valve according to claim 8 wherein during said conjoint movement, said outer sealing member slides away from said inlet to provide said open position upon said outer sealing surface aligning with said outlet.

11. A valve according to claim 8 wherein said sealing members and said biasing elements are arranged concentrically within said bore.

12. A valve according to claim 1 wherein said valve provides pressure relief to an oil pump in an engine lubrication system.

13. A valve according to claim 1 further comprising an abutment between said plungers to limit relative movement therebetween and to cause conjoint movement of said plungers to said open position.
